(19) United States
(12) Patent Application Publication
(10) Pub. No.: US 2007/0147429 A1
(43) Pub. Date: Jun. 28, 2007

(54) Stream file format for digital video recording

(75) Inventors: Jun Shi, Shanghai (CN); Jingwei Tan, Shanghai (CN); Liang Gan, Shanghai (CN); Philip Steven Newton, Eindhoven (NL); Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/561,129

(22) PCT Filed: Jun. 14, 2004
(86) PCT No.: PCT/IB04/50899

§ 371 Date: Dec. 16, 2005

Related U.S. Application Data
(60) Provisional application No. 60/479,235, filed on Jun. 17, 2003.

(51) Int. Cl. H04J 3/24

(52) U.S. Cl. 370/473; 370/476

(57) ABSTRACT

A method of recording an MPEG compliant transport stream selected by a user on a storage media. The method comprising: receiving the transport stream, the transport stream comprising transport stream packets; removing stuffing bytes from each transport stream packet in the transport stream containing stuffing bytes; recording all transport stream packets on the storage media; and recording an entry in a program information file on the storage media indicating that stuffing bytes were removed from the transport stream.

The present invention relates to the field of MPEG-2 transport streams; more specifically, it relates to an efficient method and apparatus for recording a MPEG-2 transport stream and playing back the recorded transport stream in a manner compliant with the MPEG-2 transport stream standard.

The Motion Pictures Experts Group-2 (MPEG-2) standard (ISO/IEC 13818-1: 1994E) is used to supply a stream of digital data to digital devices such as set-top boxes (STB), digital television (DTV) and more recently to interactive DTV, personal computers, hand held devices and other devices intended for interactive applications.

While current recording and playback methods, such as partial transport stream recording, have been sufficient for STB and DTV applications, the overhead in processing time associated with partial transport streams is prohibitive in the case of interactive platforms such as the DVB organizations Multimedia Home Platform (DVB-MHP) and DTV Application Software Environment (DASE). Further, environments such as MHP require access to information not available using partial transport streams.

A first aspect of the present invention is a method of recording an MPEG compliant transport stream selected by a user on a storage media, comprising: receiving the transport stream, the transport stream comprising transport stream packets; removing stuffing bytes from each transport stream packet in the transport stream containing stuffing bytes; recording all transport stream packets on the storage media; and recording an entry in a program information file on the storage media indicating that stuffing bytes were removed from the transport stream.

A second aspect of the present invention is a method of playing back an MPEG compliant transport stream selected by a user from a storage media, comprising: (a) recoding the transport stream by: receiving the transport stream, the transport stream comprising transport stream packets; removing stuffing bytes from each transport stream packet in the transport stream containing stuffing bytes; recording all transport stream packets on the storage media; and recording an entry in a program information file on the storage media indicating that stuffing bytes were removed from the transport stream; (b) reading out each transport stream packet from the transport stream and the entry in the program information file; and (c) adding stuffing bytes to each transport stream packet in the transport stream from which stuffing bytes were removed prior to recording based on the entry in the program information file indicating stuffing bytes were removed from the transport stream.

A third aspect of the present invention is an apparatus for recording and playing back an MPEG compliant transport stream selected by a user on a storage media, comprising: means for receiving the transport stream, the transport stream comprising transport stream packets; means for removing stuffing bytes from each transport stream packet in the transport stream containing stuffing bytes; means for recording all transport stream packets on the storage media; means for recording an entry in a program information file on the storage media indicating that stuffing bytes were removed from the transport stream; means for reading out each transport stream packet from the transport stream and the; and means for adding stuffing bytes to each transport stream packet in the transport stream from which stuffing bytes were removed prior to recording based on the entry in the program information file indicating stuffing bytes were removed from the transport stream.

A fourth aspect of the present invention is An apparatus for recording and playing back an MPEG compliant transport stream selected by a user on a storage media, comprising: a transport stream de-multiplexer and decryptor receiving the transport stream, the transport stream comprising transport stream packets, the transport stream de-multiplexer and decryptor adapted to generate a video elementary stream and an audio elementary stream from the transport stream; a stream modifier coupled to the transport stream de-multiplexer and decryptor, the stream modifier adapted to receive the transport stream from the transport stream de-multiplexer and decryptor, the stream modifier further adapted to remove stuffing bytes from each transport stream packet in the transport stream containing stuffing bytes; a recording apparatus adapted to record all transport stream packets on the storage media, the stream modifier further adapted to send a signal to the recording apparatus, the signal indicating that stuffing bytes were removed from the transport stream and the signal recorded by the recording apparatus; a stream de-modifier coupled between the storage apparatus and the transport stream de-multiplexer and decryptor, the stream de-modifier adapted to reading out each transport stream packet from the transport stream and further adapted to add back all stuffing bytes to each transport stream packet removed by the stream modifier prior to recording based on the entry in the signal indicating stuffing bytes were removed from the transport stream; and an audio and video decoder and presenter adapted to convert the a video elementary stream and an audio elementary stream to a playable output signal.

The features of the invention are set forth in the appended claims. The invention itself, however, will be best understood by reference to the following detailed description of an illustrative embodiment when read in conjunction with the accompanying drawings, wherein:

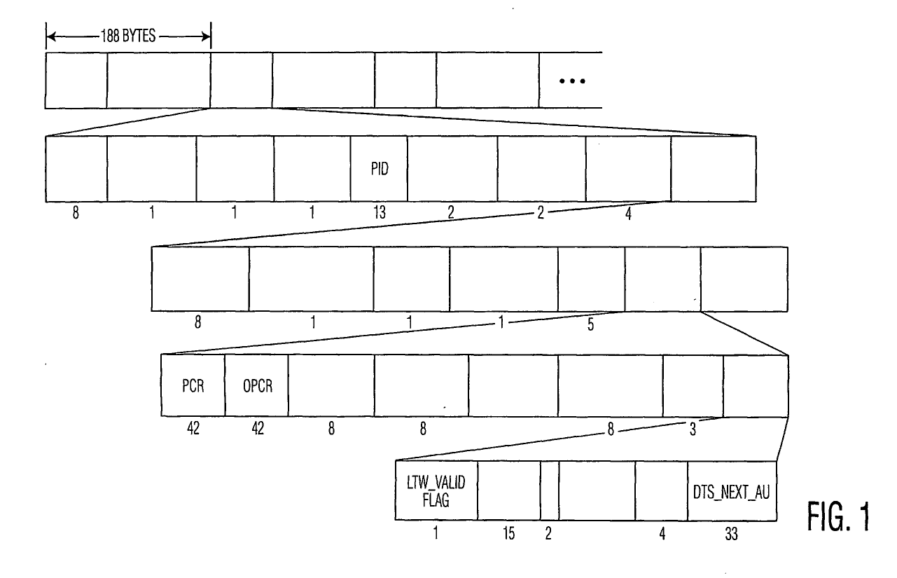

FIG. 1 is a schematic diagram of the data structure of an MPEG-2 transport stream;

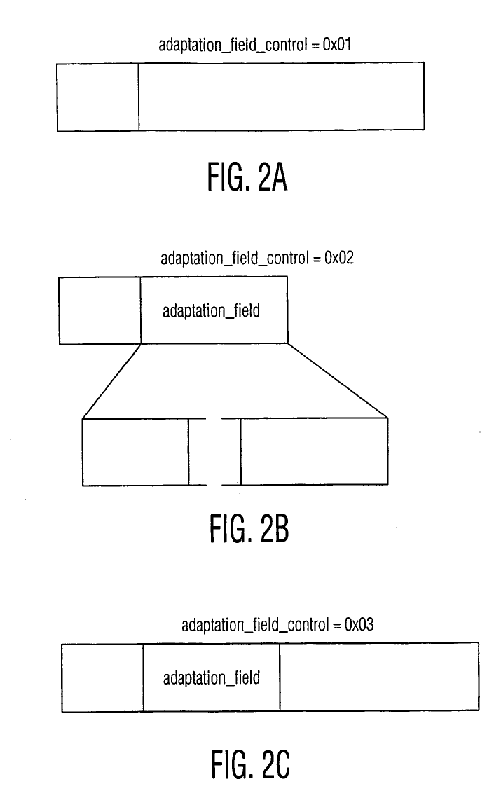

FIGS. 2A, 2B and 2C are schematic diagrams illustrating the three allowed payload configurations of a MPEG-2 transport stream;

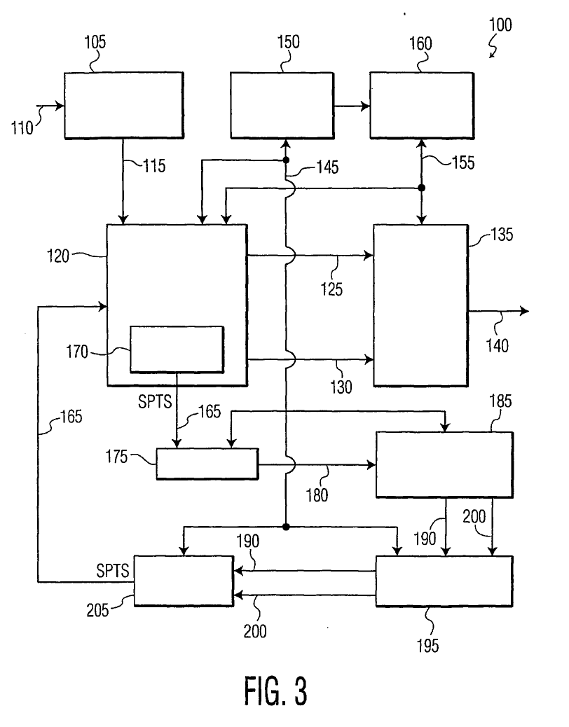

FIG. 3 is a schematic diagram of a device for receiving, playing, recording and playing back of recorded transport streams according to the present invention;

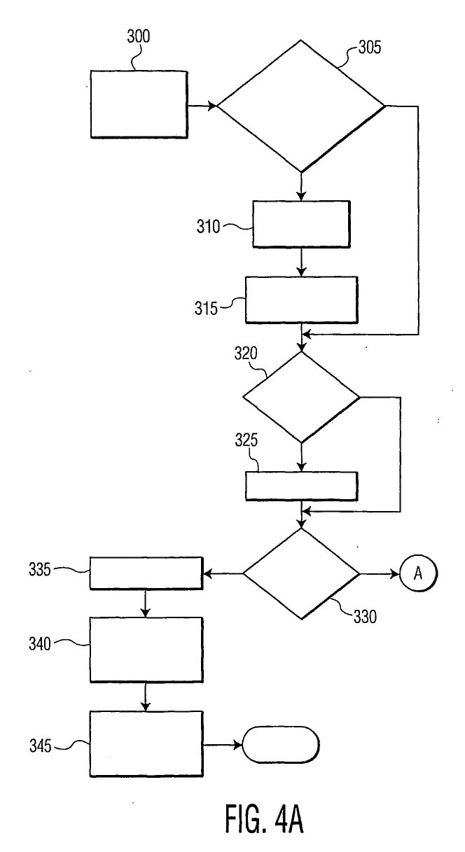

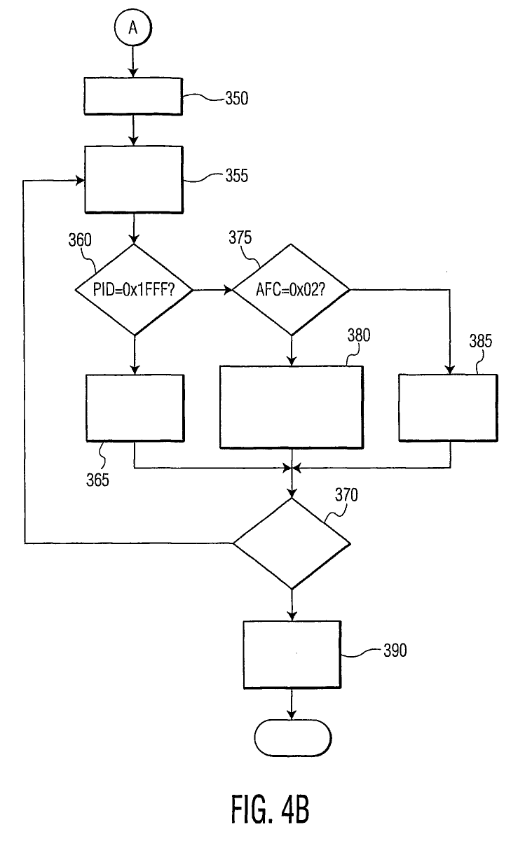

FIGS. 4A and 4B are flow diagrams illustrating the method of recording transport streams according to the present invention; and

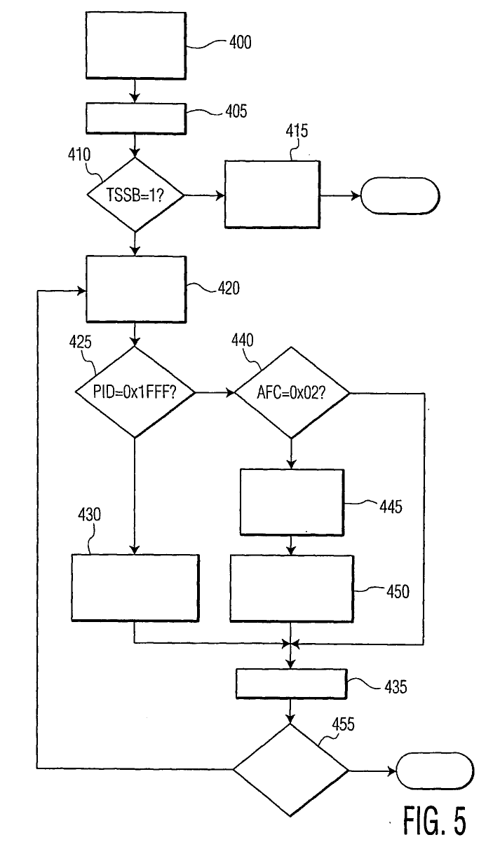

FIG. 5 is a flow diagram illustrating the method of playing back recorded transport streams according to the present invention.

The term and data structures of MPEG-2 are used in describing the present invention. It should be understood that the term MPEG-2 may be replaced by MPEG-1, MPEG-4, MPEG-7, digital satellite system (DSS) data structures or other standards that share common data stream structures with or are built upon the MPEG-2 standard. Further, the term MPEG is intended to cover all these aforementioned standards.

FIGS. 1, 2A, 2B and 2C are provided as an aid to understanding the present invention and merely illustrate the MPEG-2 standard digital data stream structure.

FIG. 1 is a schematic diagram of the data structure of an MPEG-2 transport stream. A transport stream may carry multiple programs, a multi-program transport stream (MPTS) or a single program (SPTS). A program is defined as a collection of program elements with a common time base, that is, a collection of elementary streams with the same PCR_PID and referenced to the same program_number (see infra). A transport stream is comprised of multiple standard size (188 byte) packets. Each packet includes a header and a payload. The header is 4 bytes and the payload is 184 bytes. Headers are divided into the following fields: a sync byte field (8 bits), a transport error indicator field (1 bit), a payload unit start indicator field (1 bit), a transport priority field (1 bit), a packet ID (PID) field (13 bits), a transport scrambling control field (2 bits), an adaptation field control field (2 bits), a continuity counter field (4 bits) and adaptation field. The PID field is of especial interest for the present invention.

Transport packets with PID values of 0x0000 (in hexadecimal notation) carry the Program Association Table (PAT). Transport packets with PID values of 0x0001 (in hexadecimal notation) carry the Conditional Access Table (CAT). Transport packets with PID values of 0x0000 to 0x1FFE (in hexadecimal notation) may be assigned as network_PID from which the Network Information Table (NIT) is generated, program_map PID (from which the Program Map Table (PMT) is generated) and PCR_PIDs, which identify specific programs, elementary_PIDs, which identify program elements or for other purposes. Transport packets with PID values of 0x1FFF (in hexadecimal notation) are defined as stuffing packets and carry no useful data, only the header containing data. They are used to ensure a constant bit-rate for the transport stream (as are stuffing bytes in other transport packets as described supra in reference to FIG. 2B).

The adaptation field is divided into the following fields: an adaptation field length field (8 bits), a discontinuity counter field (1 bit), a random access indicator field (1 bit), an elementary stream priority indicator field (1 bit), a field of 5 flags pointing to an optional fields field and a stuffing bytes field (variable bits). The adaptation field length field and the stuffing bytes field are of especial interest for the present invention The optional fields field is further divided into a program clock reference (PCR) field (42 bits), a old program clock reference field (OPCR) (42 bits), a splice counter field (8 bits), a transport private data length field (8 bits), a transport private data field (variable bits), an adaptation field extension length field (8 bits) and a field of three flags (3 bits) pointing to an optional fields field. The PCR field is of passing interest for the present invention and he optional fields field is further divided into fields as illustrated in FIG. 1

FIGS. 2A, 2B and 2C are schematic diagrams illustrating the three allowed payload configurations of a MPEG-2 transport stream. The adaptation_field_control variable of the adaptation field control field can have three values, 0x01, 0x02 and 0x03 (in hexadecimal notation notation). When the adaptation_field_control=0x01 then the entire payload is data relating to audio or video. When the adaptation field control=0x02 then the packet contains only an adaptation field (no payload), and the adaptation field contains stuffing bytes. In this case the adaptation field length field is 183 and the number of stuffing bytes can be determined by parsing this packet according to MPEG-2 syntax (See FIG. 1). A stuffing byte is defined as a byte of data containing a 1 in each of the eight bit positions of the byte, i.e has the value “1 1 1 1 1 1 1 1” in binary notation. When the adaptation_field_control=0x03 then the payload includes an adaptation field followed by data relating to audio or video.

FIG. 3 is a schematic diagram of a device for receiving, playing, recording and playing back of recorded transport streams according to the present invention. In FIG. 3, a receiver 100 includes a tuner and demodulator 105 for receiving an input 110 and for outputting a digital transport stream 115. In the case where a transport stream is supplied directly, tuner and demodulator 105 may not be required. Transport stream 115 may be a MPTS or a SPTS. Transport stream 115 is converted by a transport stream de-multiplexer and decryptor 120 in a video elementary stream (VES) 125 and an audio elementary stream (AES) 130 which are presented to an audio and video decoder and presenter 135, which generates playable (on a TV or other device) output 140.

A first function of transport stream de-multiplexer and decryptor 120 is to de-multiplex transport stream 115 into multiple programs (if transport stream 115 is a MPTS), and in response to user input based on bi-directional user control signals 145 entered in user controller 150, select a program to convert into VES 125 and AES 130. A second function of transport stream de-multiplexer and decryptor 120 is to decrypt programs that are encrypted via bi-directional access control signals 155 from/to conditional access controller 160. A third function of transport stream de-multiplexer and decryptor 120 is to extract a single program (from a MPTS) selected by the user and then generate a SPTS 165 that contains only the single selected program prior to recording the SPTS. To this end, transport stream de-multiplexer and decryptor 120 includes a SPTS generator 170, which generates SPTS 165 and passes SPTS 165 to a transcoder 175.

If transport stream 115 is a MPTS, SPTS generator generates a SPTS containing a single user selected program, from transport stream 115. SPTS generator 170 selects transport all packets containing Service Information (SI) Tables. SI Tables include PAT, NIT, PMT, CAT, Service Description Table (SDT), Discontinuity Information Table (DIT), Event Information Table (EIT) and all PCR and elementary packets containing audio and video data based on the value in the PID field. This is known as PID filtering. Tables specific for an environment, such as Bouquet Information Tables (BAT), Running Status Table (RST), Time Offset Table (TOT) and Stuffing Table (ST) used by DVB-MHP are also selected. Packets containing tables may be altered to remove information not specific to the selected program or left intact for those applications (such as DVB-MHP) that can access information not directly related to the single program. SPTS generator 170, re-multiplexes the selected packets into SPTS 165 retaining the piecewise constant bit-rate of transport stream 115. Consequently, stuffing packets are added as necessary and stuffing bytes added to individual packets as necessary to maintain the original bit-rate of transport stream 115. Depending upon the exact MPTS to SPTS method used, PCRs and OPCRs in some or all transport stream packets may need to be modified.

If transport stream 115 is a SPTS then transport stream de-multiplexer and decryptor 120 will pass transport stream 115 directly to transcoder 175.

Because, the amount of space on a storage media is limited, it may be desirable to reduce the size of SPTS 165 before recording the SPTS even though this will add some processing time before recording and during playback. Transcoder 175 is used to compress SPTS 165 in order to reduce the amount of space on the storage media required. The user, through user control signals 145 from user controller 150 may select no compression or choose among several types of compression such as lowering the bit-rate or eliminating certain picture types (such as P-Pictures). Transcoder 175 generates transcoded SPTS 180 which is received by a stream modifier and file generator 185.

Stream modifier and file generator 185 is used to remove stuffing packets and stuffing bytes from non-stuffing packets from transcoded SPTS 180 in order to reduce the amount of space on the storage media required. The user, through user control signals 145 from user controller 150 may select to remove or not remove stuffing. Stream modifier and file generator 185 removes stuffing bytes and stuffing packets (if so indicated by the user) and generates modified SPTS 190, which is received and recorded by a recording apparatus 195. How stuffing is removed is illustrated in FIGS. 4A and 4B and discussed infra.

Stream modifier and file generator 185 also generates program information file (PIF) data 200, which is received and recorded by recording apparatus 195 into a PIF file on the recording media. The PIF file contains at least a Transport Stream Stuffing Bytes (TSSB) flag that indicates whether stuffing has been removed or not removed from modified SPTS 190. The PIF file may further contain data indicating the program name and the start and stop positions of modified SPTS 190 recorded on the storage media and information related to the program contained in the SPTS. More than one SPTS may be stored, and all PIF data 200 may be stored in a single PIF file in a predetermined location on the storage media.

Recording apparatus 195 may be a hard disk drive (HDD), an optical disc drive (either compact disk (CD) or digital video disk (DVD), a tape drive or other type of magnetic or optical storage.

For playback of a recorded program, the user, through user control signals 145 from user controller 150, may select a program for playback and the corresponding modified SPTS 190 and corresponding PIF data 200 are read from recording apparatus 195 received by stream de-modifier 205. Stream de-modifier restores stuffing packets and stuffing bytes to modified SPTS (if they were removed before recording) to reproduce SPTS 165 which is presented to transport stream de-multiplexer and decryptor 120. How stuffing is restored is illustrated in FIG. 5 and discussed infra. Restoring stuffing bytes and stuffing packets ensures the bit-rate of transcoded SPTS 180 (or SPTS 165 if no transcoding was performed) is restored.

It should be noted that if transport stream 115 is encrypted, then in order to protect a service provider's property, SPTS 165 is encrypted as well.

FIGS. 4A and 4B are flow diagrams illustrating the method of recording transport streams according to the present invention. In step 300, a transport stream is received. In step 305, it is determined if the received transport stream is a MPTS or a SPTS. If the received transport stream is a MPTS then in step 310, the user selects a single program. In step 315, the selected program is extracted from the transport stream and a SPTS is generated as described supra. Next, in step 320, the user decides if, in order to save storage space, the quality of the recording should be changed. If in step 305, it was determined that the received transport stream is a SPTS then the method proceeds directly to step 320.

If in step 320, the user decides to change quality of recording, then in step 325 the SPTS is transcoded as described supra otherwise, the method proceeds directly from step 320 to step 330. Next, in step 330 the user decides if stuffing bytes in packets and stuffing packets should be removed in order to reduce the amount of space on the storage media required. If in step 330, the user decides not to remove stuffing bytes and stuffing packets, the method proceeds to step 335. In step 335, the variable TSSB is set equal to 0 (stuffing not removed). In step 340 the PIF is recorded and in step 345, the SPTS is recorded.

If in step 335, the user decides to remove stuffing from the SPTS then the method proceeds to step 350. In step 350, the variable TSSB is set equal to I (stuffing is removed). Next in step 355, the first (or next) packet is received from the SPTS. It may be necessary to buffer the SPTS or the following steps may be performed real time depending upon the bit-rate of the SPTS and the speed of the processor performing the following steps.

In step 360, it is determined if the value encoded in the PID field (see FIG. 1) of the current packet is 0x1FFF (in hexadecimal notation), that is, is the packet a stuffing packet? If the packet is a stuffing packet then in step 365, only the header of the current packet is stored (the first 4 bytes of the packet, which includes the PID field). The method then proceeds to step 370.

If in step 360, the PID is not equal to 0x1FFF, then in step 375, it is determined if the value encoded in the adaptation field control field, adaptation_field control (see FIGS. 1 and 2B), is 0x02 (in hexadecimal notation). In other words, does the packet contain both data bytes and stuffing bytes? If in step 375, adaptation_field_control=0x02 then in step 380, the stuffing bytes are removed. The number of stuffing bytes (NSB) may be calculated by subtracting the value (L), which can be determined by parsing this packet according to MPEG-2 syntax (see FIG. 1), from 184. NSB=184-L. The first 188-NSB bytes of the current packet are recorded. The method then proceeds to step 370.

If in step 375 adaptation_field_control is not equal to 0x02, then in step 385, the entire current packet is recorded and the method proceeds to step 370. In step 370, it is determined if there is another packet to be processed. If there is another packet to be processed, the method loops to step 355; otherwise in step 390, the PIF is recorded and recording is complete.

FIG. 5 is a flow diagram illustrating the method of playing back recorded transport streams according to the present invention. In step 400, the user selects a program to be played back and in step 405 the corresponding PIF (or data from the PIF for the selected program) is read. Next, in step 410, it is determined if TSSB=1, that is, was stuffing removed from the transport stream for the selected program? If stuffing was not removed (TSSB=0) then in step 415, the entire SPTS corresponding to the program is read out of storage and sent to transport stream de-multiplexer and decryptor 120 (see FIG. 3) and the method is complete.

If in step 410, it is determined that stuffing was removed (TSSB=1) then in step 420, the first (or next) packet is read from the storage media. In step 425, it is determined if the value encoded in the PID field (see FIG. 1) of the current packet is 0x1FFF (in hexadecimal notation), that is, is the packet a stuffing packet? If the packet is a stuffing packet then in step 430, 184 stuffing bytes are added to the packet and the method then proceeds to step 435.

If in step 425, the PID is not equal to 0x1FFF, then in step 440, it is determined if the value encoded in the adaptation field control field, adaptation_field_control (see FIGS. 1 and 2B), is 0x02 (in hexadecimal notation). If in step 440, adaptation_field_control=0x02 then in step 445 the value (L) is determined by parsing this packet according to MPEG-2 syntax (see FIG. 1). Then in step 450, 184-L stuffing bytes are added to the packet where L=adaptation_field_length as described supra. The method then proceeds to step 435.

If in step 440 adaptation_field_control is not equal to 0x02, then the method proceeds directly to step 435. In step 435 the current packet is sent to transport stream de-multiplexer and decryptor 120 (see FIG. 3). Buffering may be required to maintain the bit-rate. Next in step 455, it is determined if there is another packet to be processed. If there is another packet to be processed the method loops to step 420; otherwise playback is complete.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. For example, it is possible to remove stuffing bytes from packets and not remove stuffing packets from the SPTS. It is also possible to remove stuffing packets from the SPTS but not remove stuffing bytes from individual packets. Therefore, it is intended that the following claims cover all such modifications and changes as fall within the true spirit and scope of the invention.

What is claimed is:

1. A method of recording an MPEG compliant transport stream selected by a user on a storage media, comprising:
receiving said transport stream, said transport stream comprising transport stream packets;
removing stuffing bytes from each transport stream packet in said transport stream containing stuffing bytes;
recording all transport stream packets on said storage media; and
recording an entry in a program information file on said storage media indicating that stuffing bytes were removed from said transport stream.

2. The method of claim 1, wherein the step of removing stuffing bytes from each transport stream packet in said transport stream containing stuffing bytes further includes determining which of said transport stream packets are stuffing packets and removing all bytes following a header of said stuffing packets from said transport stream packets determined to be stuffing packets.

3. The method of claim 1, wherein the step of removing stuffing bytes from each transport stream packet in said transport stream containing stuffing bytes further includes determining which transport stream packets contain adaptation fields followed by only stuffing bytes and removing all bytes following said adaptation field from transport stream packets containing adaptation fields followed by only stuffing bytes.

4. The method of claim 1, wherein said transport stream is a single program stream.

5. The method of claim 1, wherein said transport stream is a multiple program transport stream and further including selecting from said transport stream a single program and converting said multiple program transport stream into a single program transport stream containing said selected single program.

6. The method of claim 5, wherein said single program transport stream contains service information table data for all programs in said multiple program transport stream.

7. The method of claim 5, wherein said single program transport stream contains service information table data adapted for an application running in a DVB-MHP or DASE environment.

8. The method of claim 1, wherein said transport stream contains service information table data adapted for an application running in a DVB-MHP or DASE environment.

9. The method of claim 1, further including compressing said transport stream.

10. The method of claim 9, wherein said compressing said transport stream includes changing the bit-rate of said transport stream, removing P-pictures from said transport stream or both changing the bit-rate of said transport stream and removing P-pictures from said transport stream.

11. A method of playing back an MPEG compliant transport stream selected by a user from a storage media, comprising:
(a) recording said transport stream by:
receiving said transport stream, said transport stream comprising transport stream packets;
removing stuffing bytes from each transport stream packet in said transport stream containing stuffing bytes;
recording all transport stream packets on said storage media; and
recording an entry in a program information file on said storage media indicating that stuffing bytes were removed from said transport stream;
(b) reading out each transport stream packet from said transport stream and said entry in said in said program information file; and
(c) adding stuffing bytes to each transport stream packet in said transport stream from which stuffing bytes were removed prior to recording based on said entry in said program information file indicating stuffing bytes were removed from said transport stream.

12. The method of claim 11, wherein the step of adding stuffing bytes to each transport stream packet in said transport stream from which stuffing bytes were removed prior to recording further includes determining which of said transport stream packets were stuffing packets and adding a sufficient number of bytes following a header of said stuffing packets following said header field to increase the length of said transport packet to a MPEG standard length.

13. The method of claim 11, wherein the step of adding stuffing bytes to each transport stream packet in said transport stream from which stuffing bytes were removed prior to recording further includes determining which recorded transport stream packets contain only header fields and adaptation fields and adding to said transport stream packets contain only header fields and adaptation fields a sufficient number of bytes following said adaptation field to increase the length of said transport packet to a MPEG standard length.

14. The method of claim 11, wherein said transport stream is a single program stream.

15. The method of claim 11, wherein said transport stream is a multiple program transport stream and recording said transport stream further includes selecting a single program and converting said multiple program transport stream into a single program transport stream containing said selected single program.

16. The method of claim 15, wherein said single program transport stream contains service information table data for all programs in said multiple program transport stream.

17. The method of claim 15, wherein said single program transport stream contains service information table data adapted for an application running in a DVB-MHP or DASE environment.

18. The method of claim 11, wherein said transport stream contains service information table data adapted for an application running in a DVB-MHP or DASE environment.

19. An apparatus for recording and playing back an MPEG compliant transport stream selected by a user on a storage media, comprising:
means for receiving said transport stream, said transport stream comprising transport stream packets;
means for removing stuffing bytes from each transport stream packet in said transport stream containing stuffing bytes;
means for recording all transport stream packets on said storage media;
means for recording an entry in a program information file on said storage media indicating that stuffing bytes were removed from said transport stream;
means for reading out each transport stream packet from said transport stream and said; and
means for adding stuffing bytes to each transport stream packet in said transport stream from which stuffing bytes were removed prior to recording based on said entry in said program information file indicating stuffing bytes were removed from said transport stream.

20. The apparatus of claim 19, wherein said transport stream is a single program stream.

21. The method of claim 1, wherein said transport stream is a multiple program transport stream and further including means for selecting a single program and means for converting said multiple program transport stream into a single program transport stream containing said selected single program.

22. The apparatus of claim 21, wherein said single program transport stream contains service information table data for all programs in said multiple program transport stream.

23. The apparatus of claim 21, wherein said single program transport stream contains service information table data adapted for an application running in a DVB-MHP or DASE environment.

24. The apparatus of claim 19, wherein said transport stream contains service information table data adapted for an application running in a DVB-MHP or DASE environment.

25. The apparatus of claim 19, further including means for compressing said transport stream.

26. The apparatus of claim 25, wherein said compressing means further includes means for changing the bit-rate of said transport stream, means for removing P-pictures from said transport stream or both means for changing the bit-rate of said transport stream and means for removing P-pictures from said transport stream.

27. An apparatus for recording and playing back an MPEG compliant transport stream selected by a user on a storage media, comprising:
a transport stream de-multiplexer and decryptor receiving said transport stream, said transport stream comprising transport stream packets, said transport stream de-multiplexer and decryptor adapted to generate a video elementary stream and an audio elementary stream from said transport stream;
a stream modifier coupled to said transport stream de-multiplexer and decryptor, said stream modifier adapted to receive said transport stream from said transport stream de-multiplexer and decryptor, said stream modifier further adapted to remove stuffing bytes from each transport stream packet in said transport stream containing stuffing bytes;
a recording apparatus adapted to record all transport stream packets on said storage media, said stream modifier further adapted to send a signal to said recording apparatus, said signal indicating that stuffing bytes were removed from said transport stream and said signal recorded by said recording apparatus;
a stream de-modifier coupled between said storage apparatus and said transport stream de-multiplexer and decryptor, said stream de-modifier adapted to reading out each transport stream packet from said transport stream and further adapted to add back all stuffing bytes to each transport stream packet removed by said stream modifier prior to recording based on said entry in said signal indicating stuffing bytes were removed from said transport stream; and
an audio and video decoder and presenter adapted to convert said a video elementary stream and an audio elementary stream to a playable output signal.

28. The apparatus of claim 27, wherein said transport stream de-multiplexer and decryptor further includes a single program transport stream generator adapted to convert said transport stream in the event said transport stream is a multiple program transport stream into a single program transport stream containing a program selected by said user, said single transport stream generator coupled to said stream modifier.

29. The apparatus of claim 28, wherein said single program transport stream contains service information table data for all programs in said multiple program transport stream.

30. The apparatus of claim 28, wherein said single program transport stream contains service information table data adapted for an application running in a DVB-MHP,or DASE environment.

31. The apparatus of claim 27, wherein said transport stream contains service information table data adapted for an application running in a DVB-MHP or DASE environment.

32. The apparatus of claim 27, further including a transcoder adapted to compress said transport stream.

33. The apparatus of claim 32, wherein said transcoder is adapted to change the bit-rate of said transport stream, is adapted to remove P-pictures from said transport stream or is adapted to both change the bit-rate of said transport stream and to remove P-pictures from said transport stream.

34. The apparatus of claim 27 wherein said recording apparatus is selected from the group consisting of hard disk drives, optical disk drives, compact disc drives and digital video disk drives.
